(19) United States
(12) Patent Application Publication
(10) Pub. No.: US 2013/0249974 A1
(43) Pub. Date: Sep. 26, 2013

(54) Method of Displaying an Autostereoscopic Image

(71) Applicant: ALIOSCOPY, Paris (FR)

(72) Inventor: Pierre Allio, Paris (FR)

(73) Assignee: ALIOSCOPY, Paris (FR)

(21) Appl. No.: 13/691,015

(22) Filed: Nov. 30, 2012

(30) Foreign Application Priority Data
Mar. 21, 2012 (FR) 1252538

(51) Int. Cl. G09G 5/02

(52) U.S. Cl. CPC G09G 5/02
USPC 345/694

(57) ABSTRACT

Method of displaying an autostereoscopic image having N viewpoints in which at least one group of three successive screen rows having first, second, and third rows, the second row is identical to the first row, and for the third row, the spatial distribution of the three sub-pixels of the autostereoscopic image is offset relative to the second row by a pitch corresponding to one sub-pixel, the offsetting being in an elementary sequence AB, where A designates the fact that a row is identical to the preceding row, and B designates applying to a row of the image relative to the preceding row a said offset of the sub-pixels of the autostereoscopic image through a pitch corresponding to one sub-pixel.

### FIELD

The present invention provides a method of displaying an autostereoscopic image.

### BACKGROUND

A first display method is known that makes use of the smallest displayable portion, the sub-pixel (or color dot). The definition of the image is increased by organizing horizontal circular permutations. The number of viewpoints is not a multiple of three. The lenses are vertical, parallel to the columns of pixels, and each lens covers an integer number of sub-pixels.

That technique is described in particular in the following patents: EP 0 697 163 and EP 1 106 016 (WO 00/10332).

If there are only two viewpoints, the lenses cover only ⅔ of a pixel and separation power is very effective.

When displaying flat images (e.g. small-sized character fonts), the image seen through the lens array locally presents color components that are visible, thereby degrading 2D/3D compatibility.

A second display method is also known that adds to the above method a permutation of one sub-pixel from one row to the next and that serves to eliminate the above-mentioned color dominants.

That technique is described in patent EP 1 779 181.

Separation power is not quite as good as in the preceding case, but there exists a limitation on passing from one lobe to another between the last (N^{th}) viewpoint and the first viewpoint for the following lobe, and this phenomenon is particularly marked when there are only two viewpoints. With two viewpoints, each eye sees one image (left or right) plus a little of the other image (right or left). Consequently, the “phantom” of the left image is visible simultaneously with the right image.

The redundant portions or portions seen twice (as can happen with high levels of contrast) are perceived as image noise situated in the physical plane of the screen.

### SUMMARY

An object of the present invention is thus to provide a method that enables the drawbacks of both of the above methods to be remedied, at least in part.

To this end, the invention provides a method of displaying an autostereoscopic image having N viewpoints, on at least a portion of a screen having display pixels arranged in rows and columns, each display pixel comprising first, second, and third sub-pixels in alignment on a common row, each sub-pixel having a different color (R, V, B), the display rows of the screen presenting the same arrangement of sub-pixels, in which method N is greater than 1 and is not equal to a multiple of 3, the three sub-pixels of each display pixel displaying three sub-pixels of corresponding color component of pixels of the autostereoscopic image coming from at least two pixels of the same rank of at least two different viewpoints, the method being characterized in that, for at least one group of three successive screen rows comprising first, second, and third rows, the second row is identical to the first row, and for the third row, the spatial distribution of the three sub-pixels of the autostereoscopic image is offset relative to the second row by a pitch corresponding to one sub-pixel, the offsetting being in an elementary sequence AB, where A designates the fact that a row is identical to the preceding row, and B designates applying to a row of the image, relative to the preceding row, said offset of the sub-pixels of the autostereoscopic image through a pitch corresponding to one sub-pixel.

Advantageously, the display sequence comprises at least one elementary sequence AB and is repeated in a display cycle having a group of vertical rows.

The display sequence may be AB and a display cycle then includes 2N rows of the screen.

The display sequence may be AAB and the display cycle then has 3N rows of the screen.

The display sequence may be ABB.

For N=2 or N=4, the display sequence extends over six rows of the screen.

For N=5, the display cycle extends over fifteen rows of the screen.

For N=8, it has twelve rows.

The display sequence may be AABB. When N is an even number (e.g. 2, 4, 8), the cycle extends over 2N rows.

For N=5, the cycle extends over twenty screen rows.

### BRIEF DESCRIPTION OF THE DRAWINGS

Other characteristics and advantages of the invention appear better on reading the following description given by way of non-limiting example and with reference to the drawings, in which:

FIG. 1a to 1d show the first above-mentioned prior art method referenced A, respectively for N=2, 4, 5, and 8 viewpoints;

FIGS. 2a to 2d show the second above-mentioned prior art method referenced B, respectively for N=2, 4, 5, and 8 viewpoints;

FIGS. 3a to 3d show a first implementation of the method of the invention with a said sequence AB obtained by alternating the first method A and the second method B, respectively for N=2, 4, 5 and 8 viewpoints;

FIGS. 4a to 4d show a second implementation of the method of the invention with a said sequence AAB in which use is made in succession of the first method A, the first method A, and the second method B;

FIGS. 5a to 5d show a third implementation of the method of the invention with a said sequence ABB in which use is made successively of the first method A, the second method B, and the second method B;

FIGS. 6a to 6d show a fourth implementation of the method of the invention with a said sequence AABB in which use is made successively of the first method A, the first method A, the second method B, and the second method B; and

FIG. 7 is a general diagram showing the inclination of the lens array or of the parallax barrier that is placed in front of the screen.

### DETAILED DESCRIPTION

In each of the methods A and B implemented herein, the sub-pixels of the pixels in a common row of the autostereoscopic image are displayed on the corresponding row of the screen. The components of any pixel of the autostereoscopic image are thus not spread over a plurality of screen rows.

In the figures, the sub-pixels (or color dots) that constitute the first display cycle (cycle No. 1) for the first pixel (n=1) are shown boxed in bold. In each case, cycle No. 1 is duplicated horizontally for the successive pixels (n>1) and vertically for the successive rows (cycle No. 2, No. 3, etc. . . . ).

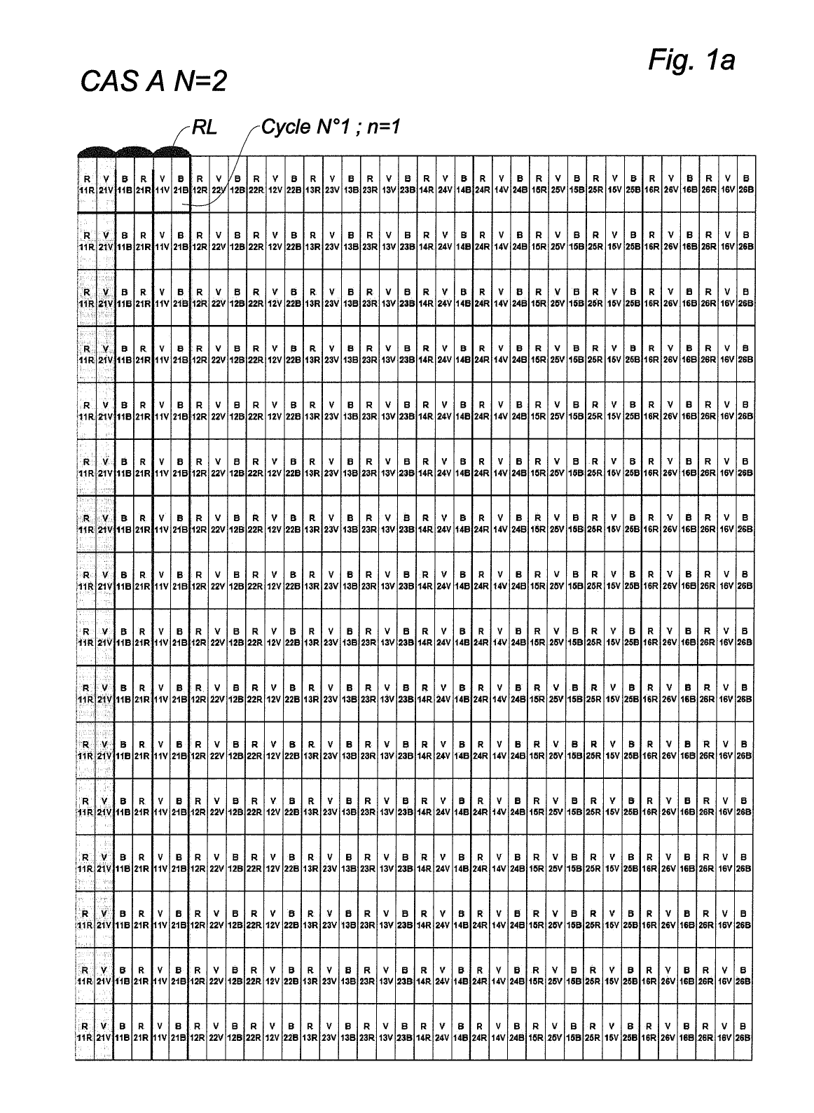

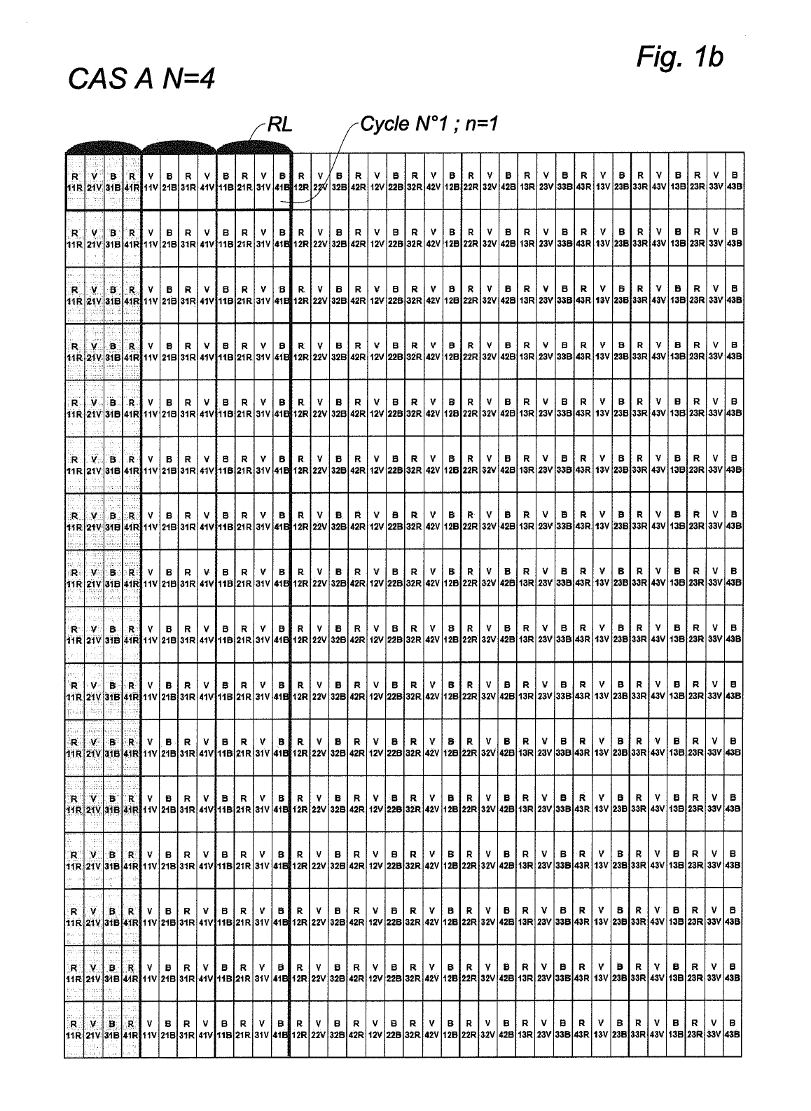

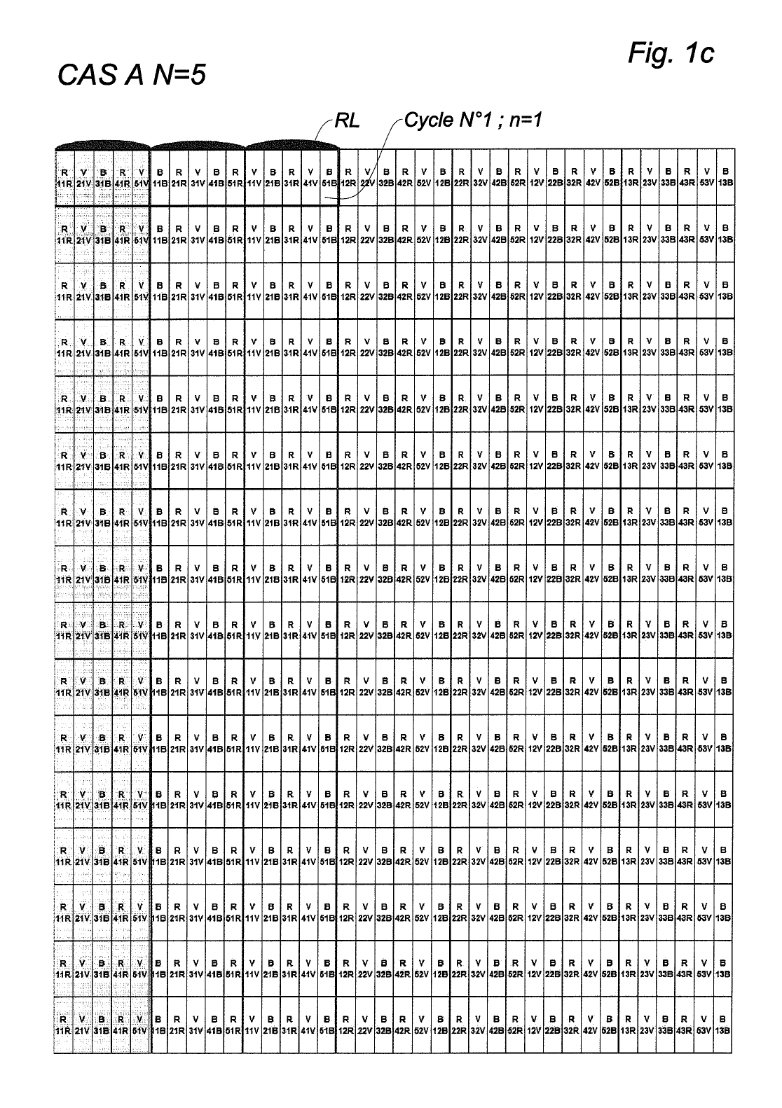

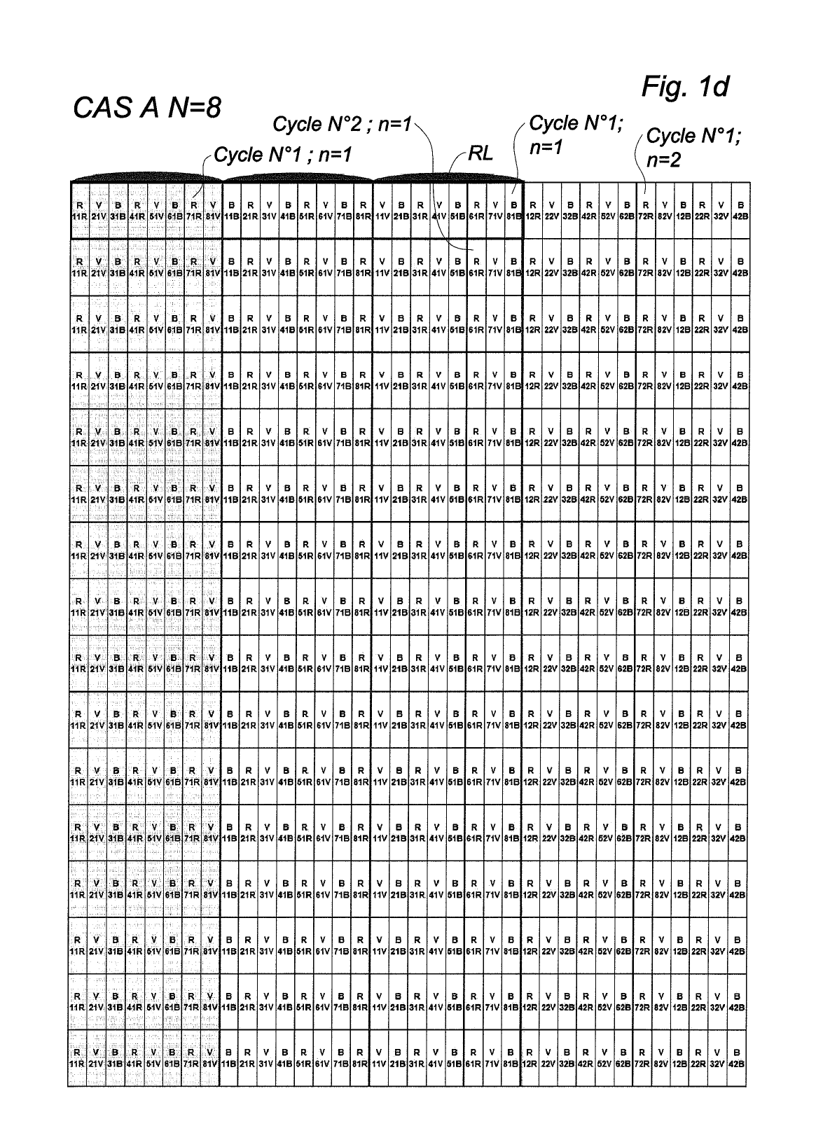

The lens array (or parallax barrier) placed in front of the screen is referenced RL. Only the lenses corresponding to the first pixel of the displayed autostereoscopic image (n=1) are shown. The orientation of the array is shown by means of bold lines. In FIGS. 1a to 1d, it is vertical, and in all the other cases it is oblique.

The sub-pixels seen through the first lens of the array RL (or the first slot of the parallax array) are shown in gray in the drawings.

The letter R designates the color of the corresponding sub-pixel (R=red, V=green, B=blue). The first digit designates the viewpoint number (lying in the range 1 to N). The second digit designates the pixel number. For example, 41V designates the green component for the fourth viewpoint of the first pixel of the displayed autostereoscopic image.

FIGS. 1a to 1d show the circular permutation of the sub-pixels that remains the same from one row to another, for the cases where N=2, 4, 5, or 8 viewpoints.

In FIG. 1a (N=2), each row for the first pixel of the autostereoscopic image thus has in succession the sub-pixel 11R corresponding to the red component of the first viewpoint, the sub-pixel 21V corresponding to the green component of the second viewpoint, the sub-pixel 11B corresponding to the blue component of the first viewpoint, the sub-pixel 21R corresponding to the red component of the second viewpoint, the sub-pixel 11V corresponding to the green component of the first viewpoint, and finally the sub-pixel 21B corresponding to the blue component of the second viewpoint, and so on for the other pixels of the row (n>1).

A cycle comprises six sub-pixels in a single row, namely 1nR, 2nV, 1nB, 2nR, 1nV, and 2nB, where n designates the number of the pixel.

In the drawing, the outline of cycle No. 1 corresponding to pixel No. 1 (n=1) in the autostereoscopic image has been emphasized. This distribution repeats horizontally along the first row for the following pixels No. 2, No. 3, etc. . . . of the autostereoscopic image, and vertically for the first pixel (n=1) and for the following pixels (n>1).

In FIG. 1b (N=4), each displayed pixel comprises for pixel No. 1 the following sub-pixels in succession 11R, 21V, 31B, 41R, 11V, 21B, 31R, 41V, 11B, 21R, 31V, and 41B, which make up cycle No. 1.

This distribution is duplicated horizontally and vertically as in the preceding case.

In FIG. 1c (N=5), the sequence corresponding to the first pixel of the autostereoscopic image is as follows:

11R, 21V, 31B, 41R, 51V, 11B, 21R, 31V, 41B, 51R, 11V, 21B, 31R, 41V, and 51B. It constitutes cycle No. 1 and it is duplicated horizontally and vertically as in FIGS. 1a and 1b.

In FIG. 1d (N=8), cycle No. 1 corresponding to the first pixel of the autostereoscopic image is as follows:

11R, 21V, 31B, 41R, 51V, 61B, 71R, 81V, 11B, 21R, 31V, 41B, 51R, 61V, 71B, 81R, 11V, 21B, 31R, 41V, 51B, 61R, 71V, and 81B, and it is duplicated horizontally and vertically as in the case of FIGS. 1a to 1c.

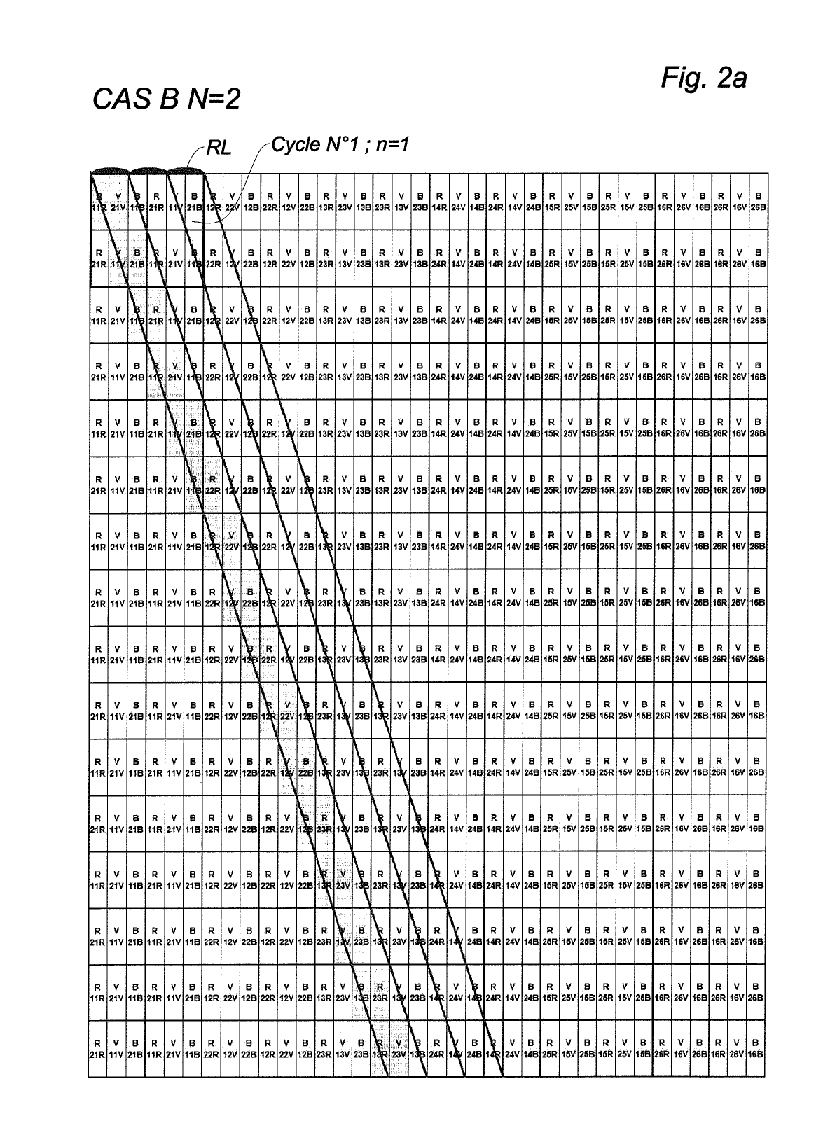

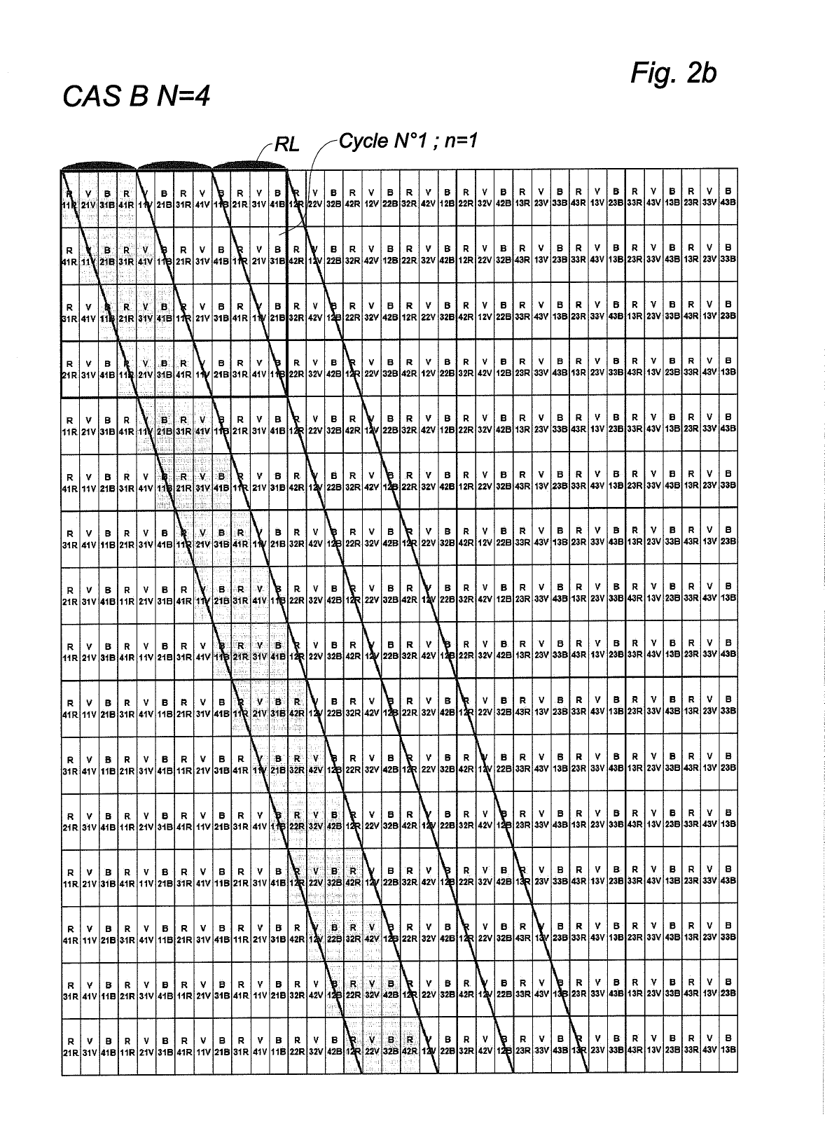

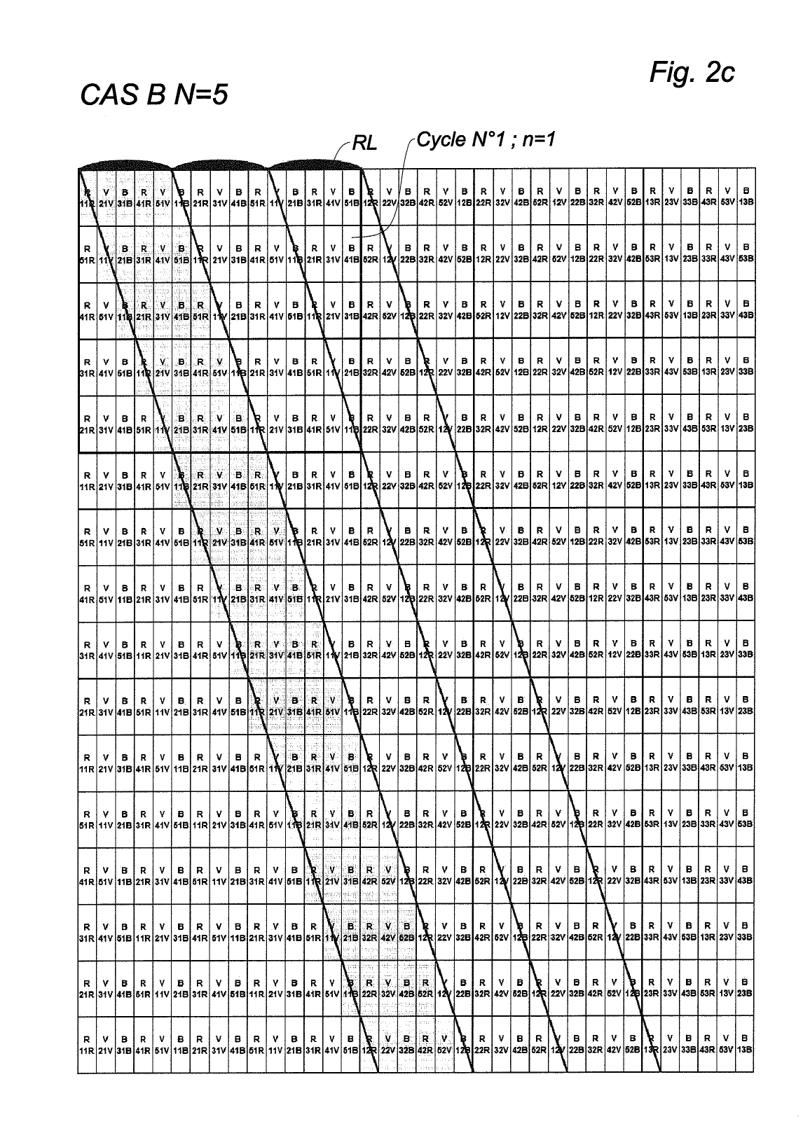

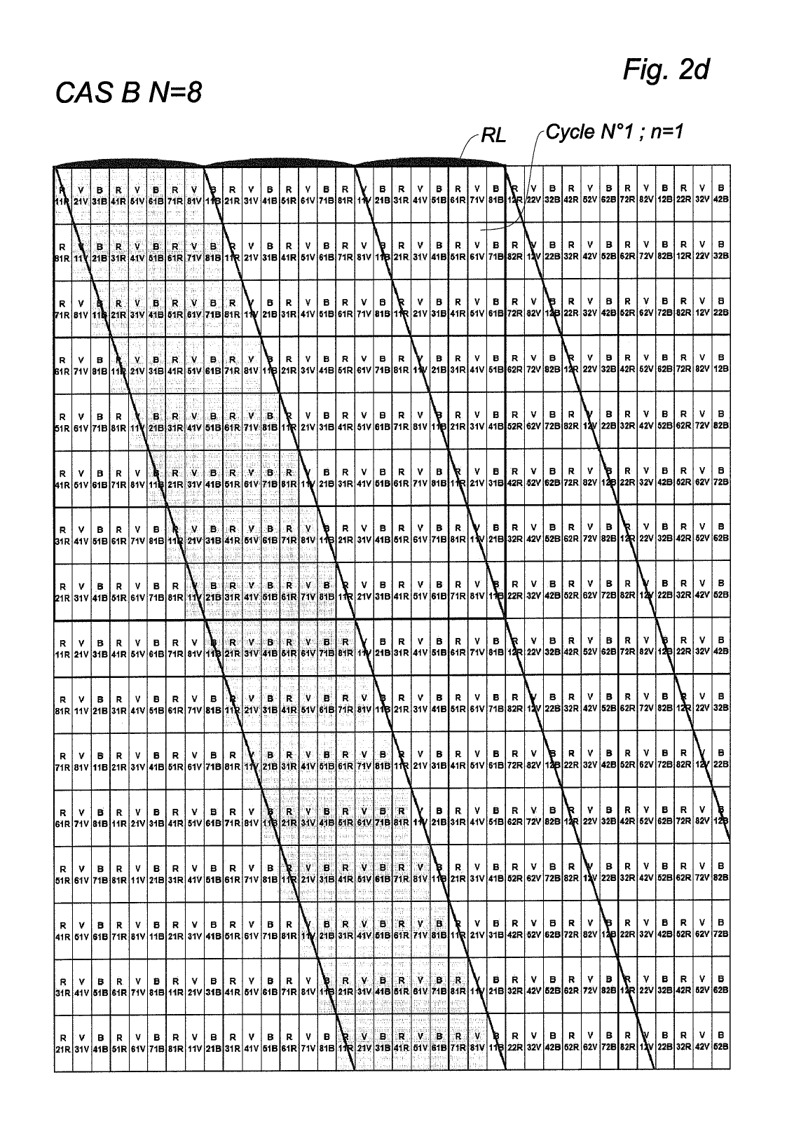

FIGS. 2a to 2d (N=2) corresponds to the case designated B of a one sub-pixel permutation of the autostereoscopic image from one row to the next.

The sub-pixels of the first pixel of the first row (and of all odd rows) of the autostereoscopic image are displayed in the sequence 11R, 21V, 11B, 21R, 11V, and 21B, whereas the sub-pixels of the first pixel of the second row (and all even rows) of the autostereoscopic image are displayed with the sequence 21R, 11V, 21B, 11R, 21V, and 11B, such that the sub-pixels of each of two viewpoints belonging to different rows of the autostereoscopic image are in alignment as a result of this offset of one pitch equal to one sub-pixel along a diagonal of sub-pixels of the screen. Cycle No. 1 then extends over two rows of the screen and it is duplicated horizontally for the successive pixels (n>1) and vertically for the first pixel (n=1) and for the following pixels (n>1).

In FIG. 2b (N=4), there is an offset of one sub-pixel from one row to the next and N=4 successive rows and four different display sequences are needed, each beginning by a circular permutation with the red component R of a different viewpoint so that the sub-pixels of any one viewpoint are in alignment on a diagonal of the sub-pixels of the screen. A cycle thus extends over four rows of the screen.

In FIG. 2c (N=5), there is likewise an offset of one sub-pixel from one to the next, and N=5 successive rows and five different display sequences are needed, each beginning by a circular permutation with the red component R of a different viewpoint so that the sub-pixels of any one viewpoint are in alignment on a diagonal of sub-pixels of the screen. A cycle thus extends over five screen rows.

Finally, in FIG. 2d (N=8), N=8 successive rows and eight different sequences are needed, each beginning by circular permutation with the red component for a different viewpoint so that the sub-pixels of any one viewpoint are displayed on a diagonal of sub-pixels of the screen. A cycle thus extends over eight rows of the screen.

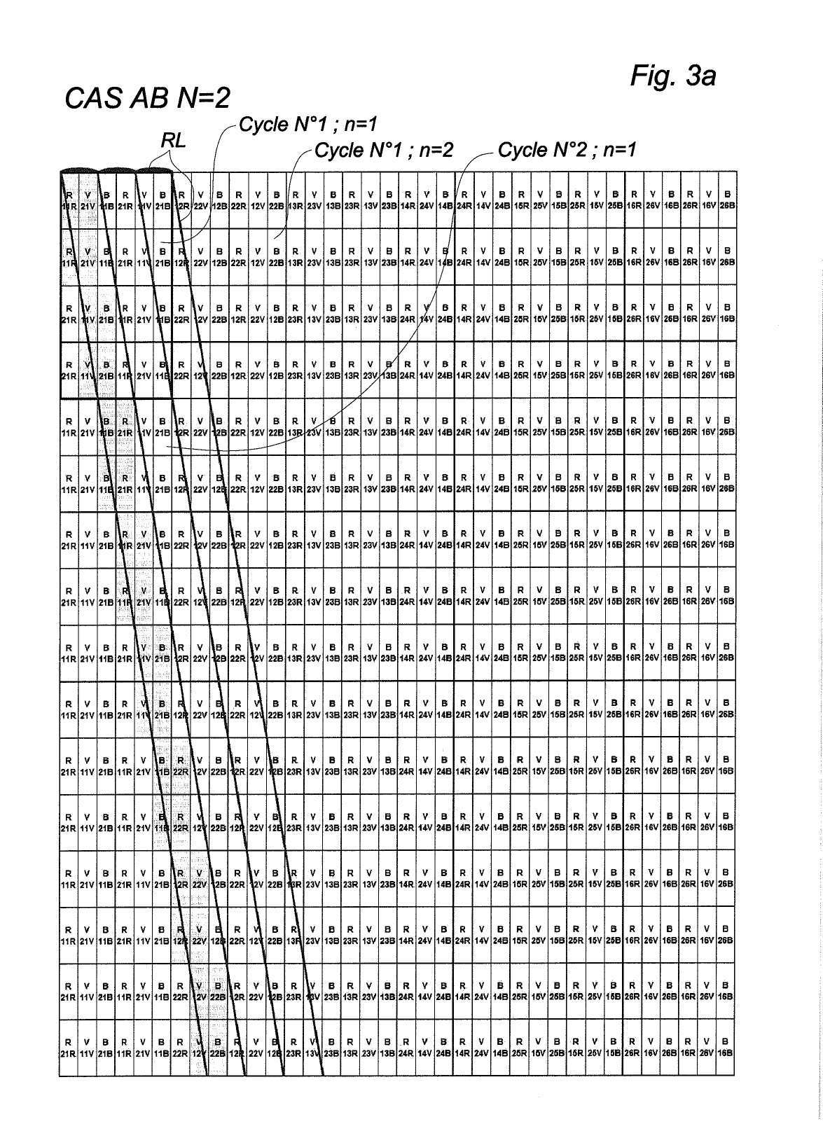

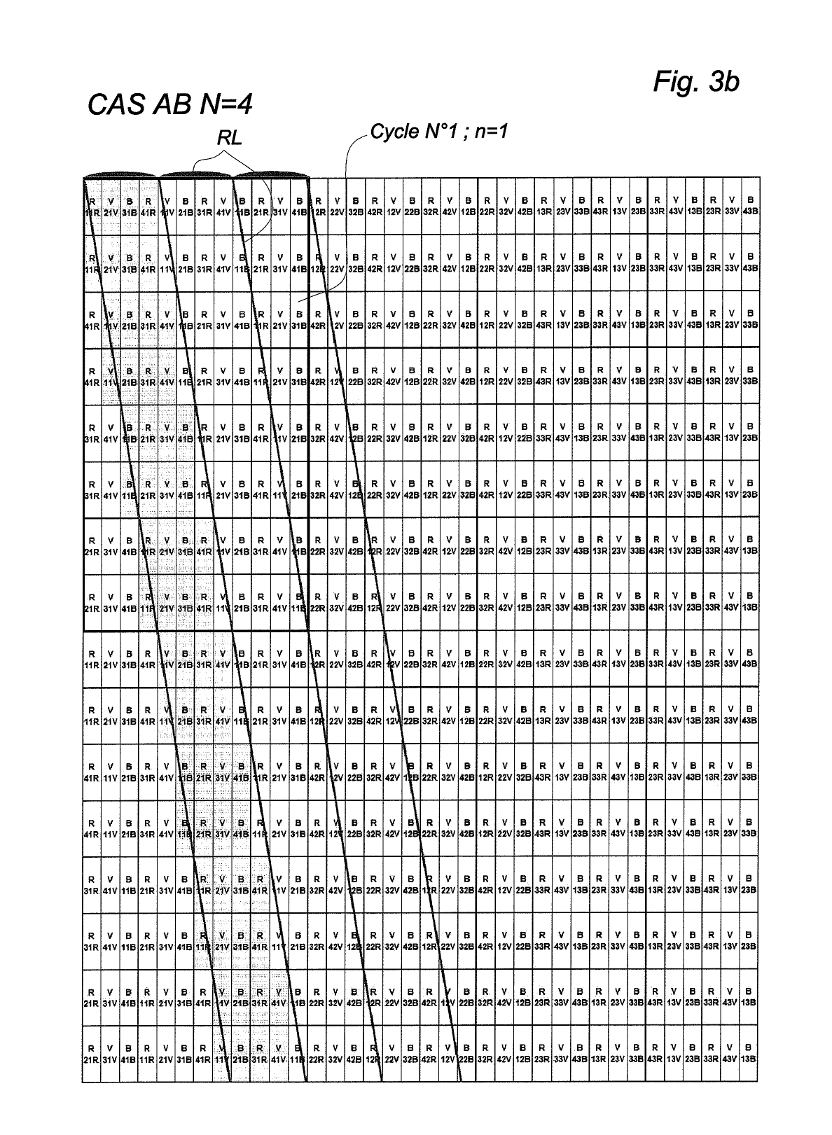

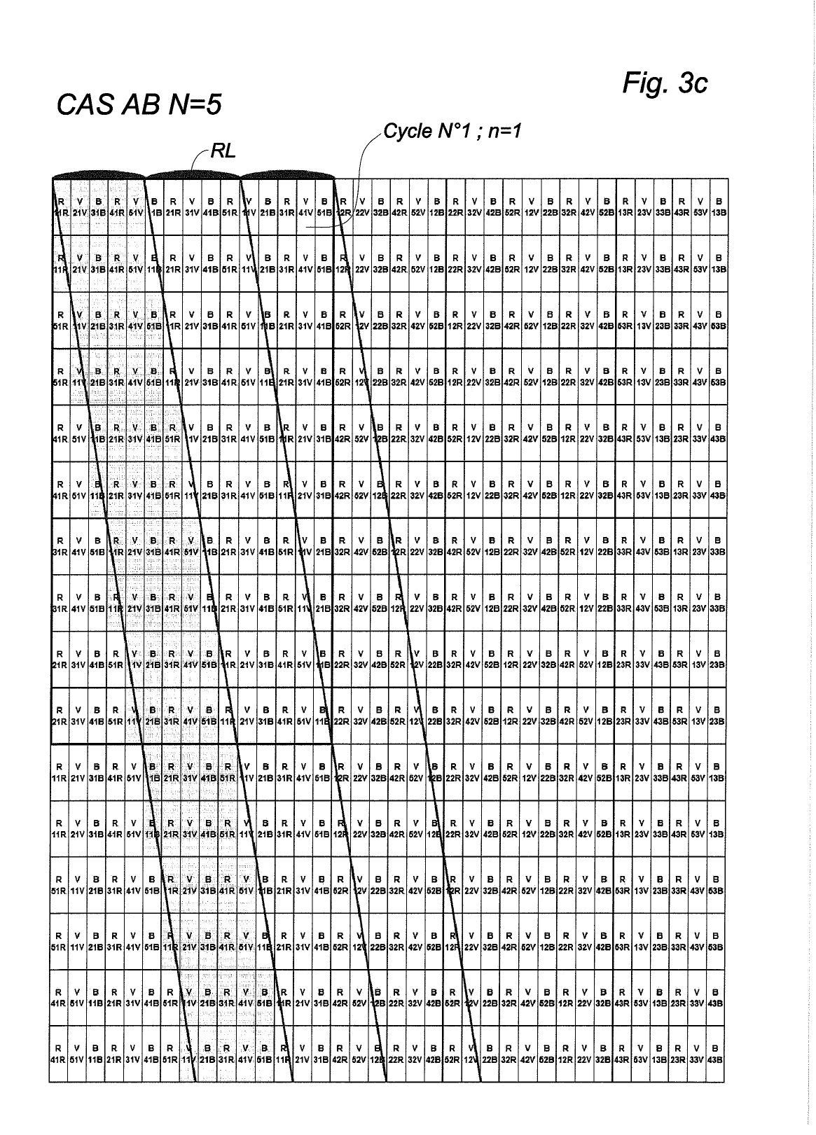

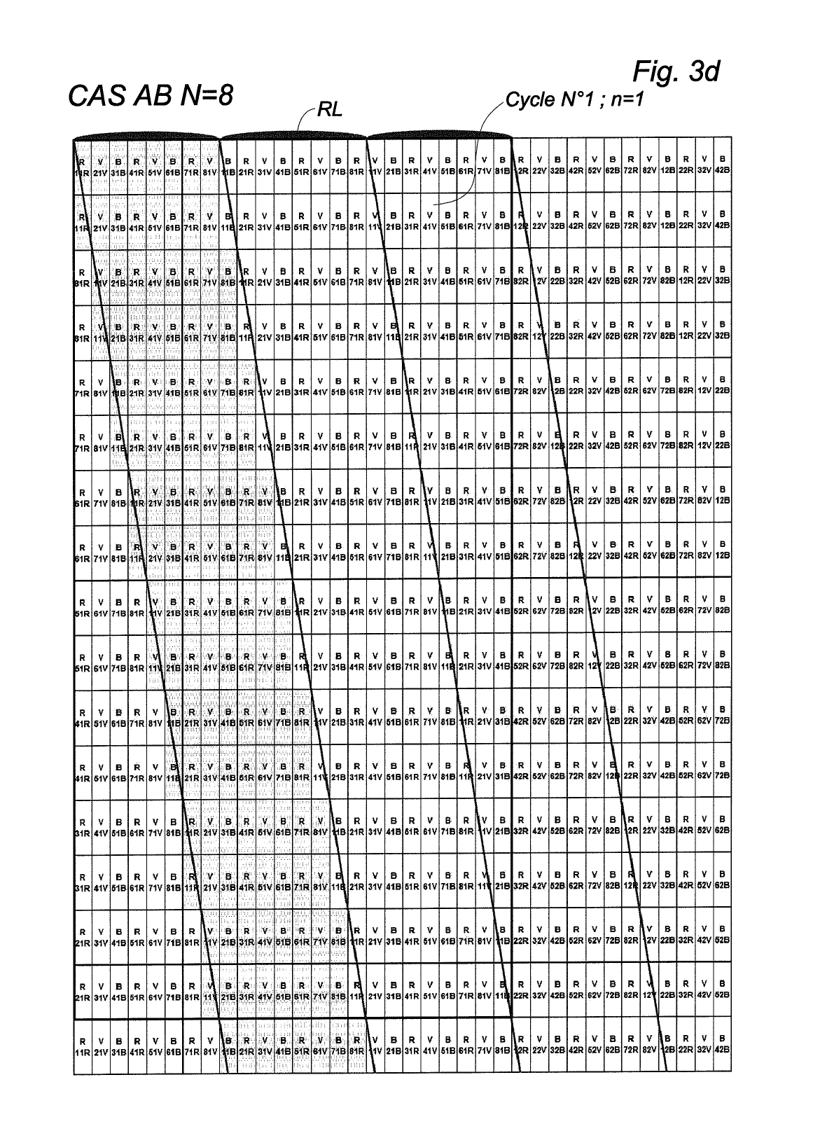

In accordance with the present invention, FIG. 3a makes use of an alternation of the two methods A and B (sequence AB). The sequence starts with a first row in which the pixels are displayed with the elementary sequence 11R, 21V, 11B, 21R, 11V, and 21B as shown in FIG. 1a. The method A is applied. The second row remains identical to the first row. The first two rows are thus identical as in the first method and they both begin with the sub-pixel 11R. The method B is applied to the third row, which means that it is subjected to an offset of one pixel relative to the second row and begins with the sub-pixel 21R, using the elementary sequence 21R, 11V, 21B, 11R, 21V, and 11B. This provides a first display sequence AB. The first method A is applied to the fourth row, which means that it is identical to the preceding row and begins with the sub-pixel 21R. The second method B is applied to the fifth row, which means that it begins with the sub-pixel 11R like the first row. This thus provides a second sequence AB.

Thus, over four successive rows a first complete cycle (cycle No. 1) is looped, which cycle comprises two sequences AB. The bold row box marks a display cycle (cycle No. 1) for the first pixel (n=1) of the autostereoscopic image, which cycle is duplicated horizontally for all of the successive pixels (n>1) and vertically for all the pixels (n≧1) and all of the successive rows (cycles No. 2, No. 3, etc. . . . ), by applying sequences AB as specified above. The sequence AB then continues from the fifth row, and so on to the last row for display on the screen.

FIG. 3b differs from FIG. 3a in the number N of viewpoints, which number is equal to 4 in this figure.

By applying the two methods in alternation, the first two rows begin with the sub-pixel 11R, the next two rows with the sub-pixel 41R, the next two rows with the sub-pixel 31R, and the next two pixels of the sub-pixel 21R, thus constituting a cycle that extends over 2N=8 rows of the screen, instead of four, with four successive sequences AB instead of two.

In FIG. 3c (N=5), the sequence AB that corresponds in this case as in the others to duplicating each row, leads to a cycle that extends over 2N=10 rows of the screen with five successive sequences AB.

With FIG. 3d (N=8), the sequence AB leads to a cycle that extends over 2N=16 rows of the screen with eight successive sequences AB.

In other words, for a sequence AB, the number of rows corresponding to one cycle is equal to 2N, and the number of successive sequences AB is equal to N.

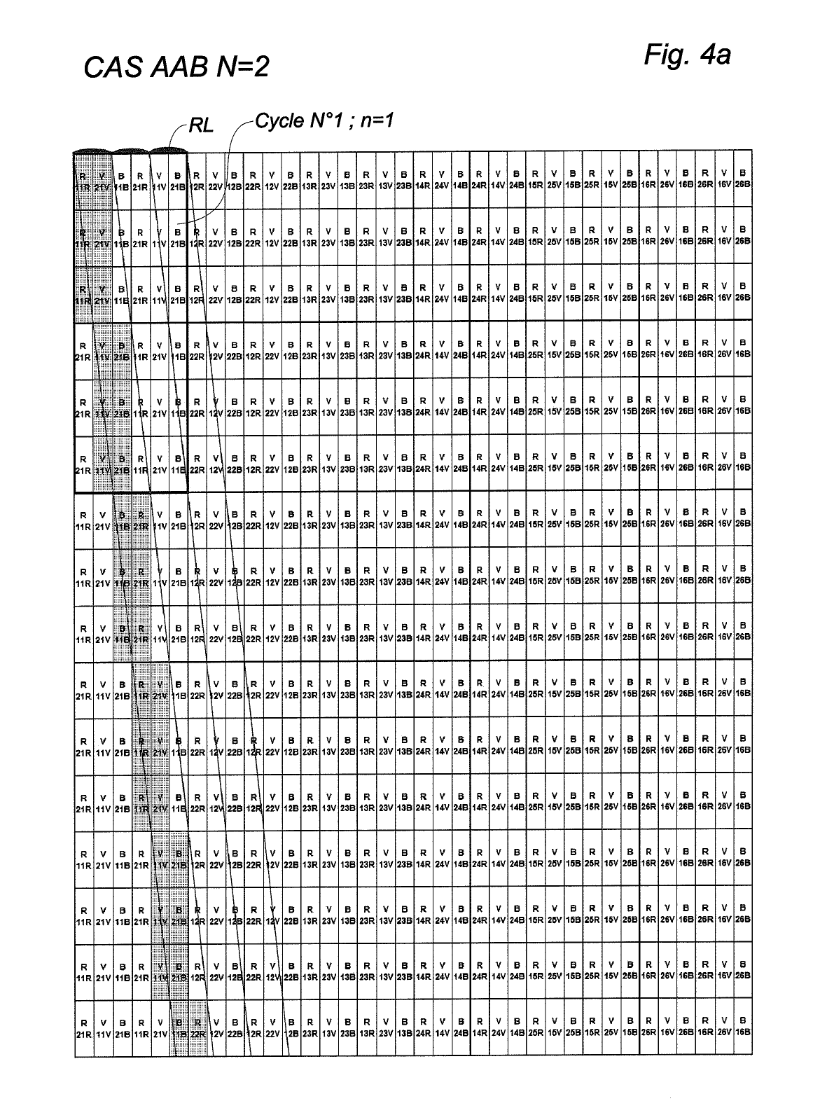

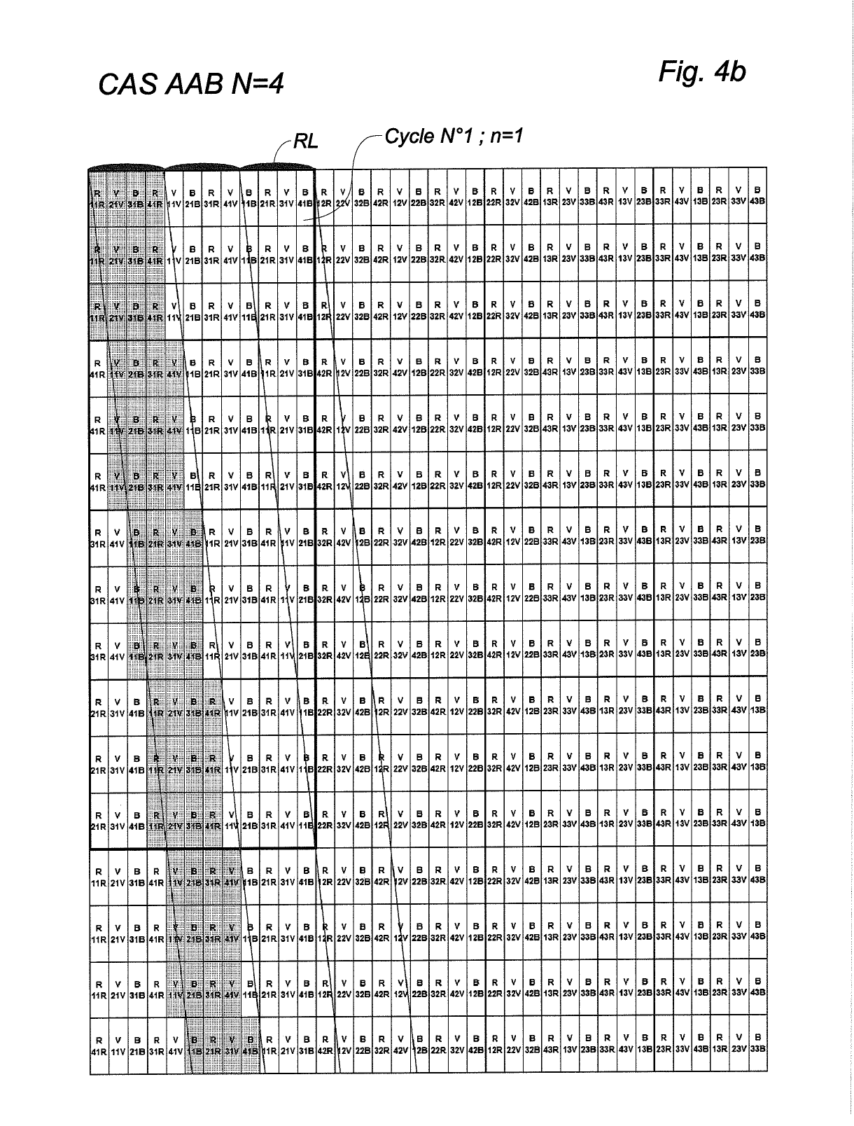

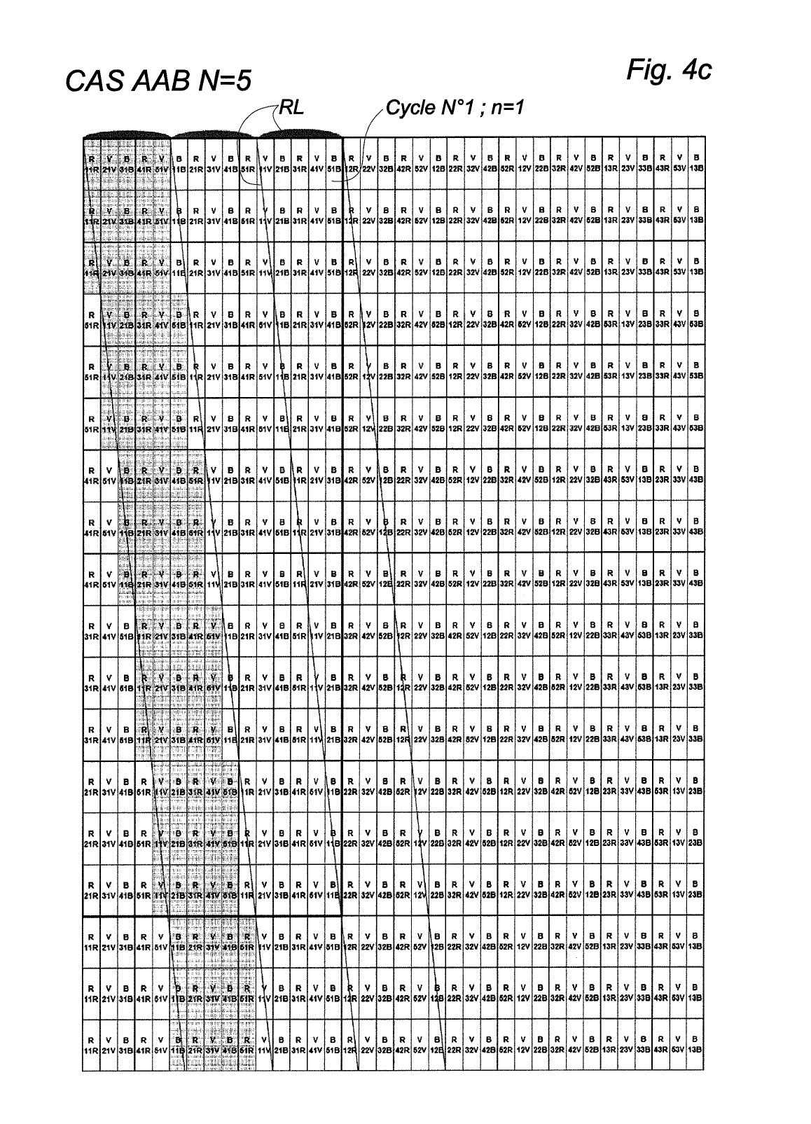

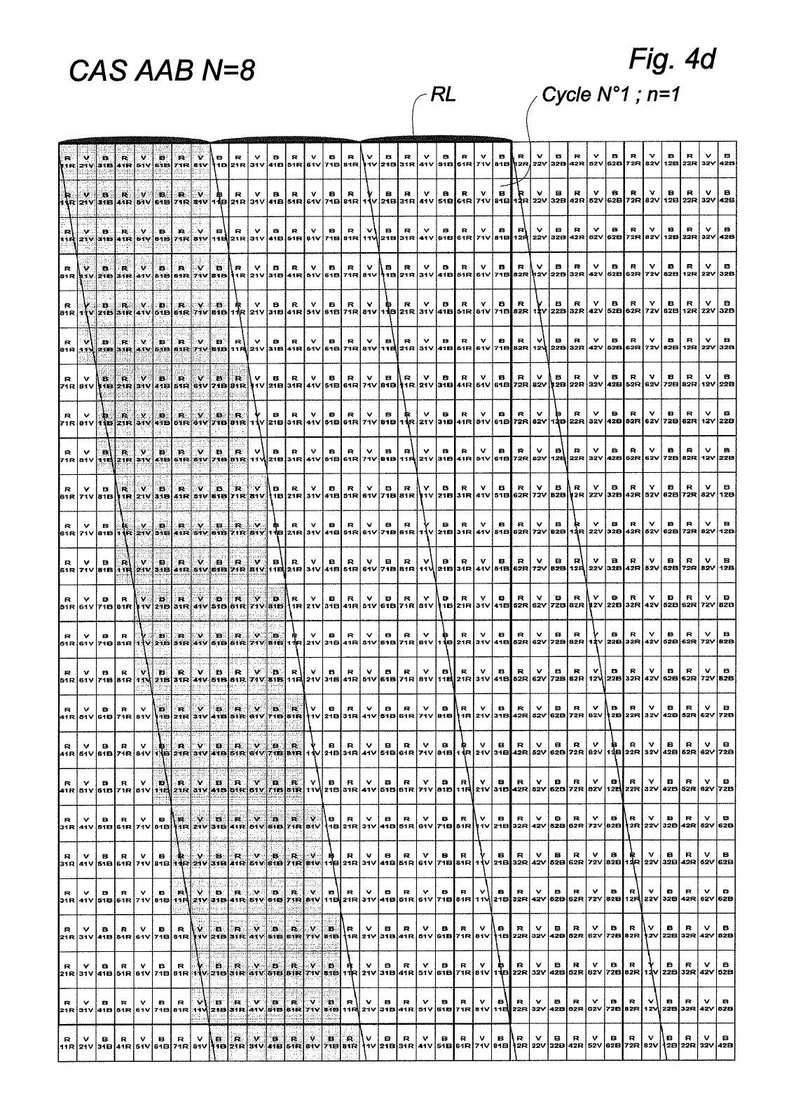

FIGS. 4a to 4d correspond to an implementation in which the method A is iterated twice after which the method B is applied, and so on (sequence AAB).

This sequence leads to groups of three successive rows that are identical.

The cycle extends over 3N rows of the screen.

In FIG. 4a (N=2), a cycle extends over 3n=6 rows of the screen.

In FIG. 4b (N=4) the cycle (cycle No. 1; N=1) extends over 3N=12 rows of the screen, the first three rows beginning with the sub-pixel 11R, the next three rows with the sub-pixel 41R, the next three rows with the sub-pixel 31R, and the next three rows with the sub-pixel 21R, thereby terminating the cycle, after which the following cycle of twelve rows (cycle No. 2; N=1) returns to a group of three rows beginning with the sub-pixel 11R

In FIG. 4c (N=5), the cycle extends over 3N=15 rows of the screen because of the presence in the sequence of viewpoint No. 5 (five groups of three identical rows).

In FIG. 4d (N=8), the cycle extends over 3N=24 rows of the screen (eight groups of three identical rows).

For a sequence AAB, the cycle extends over 3N rows of the screen. Cycle No. 1 for the first pixel (bold box in the figures) is duplicated horizontally for the following pixels (n>1) and vertically for all of the pixels in groups of 3N rows.

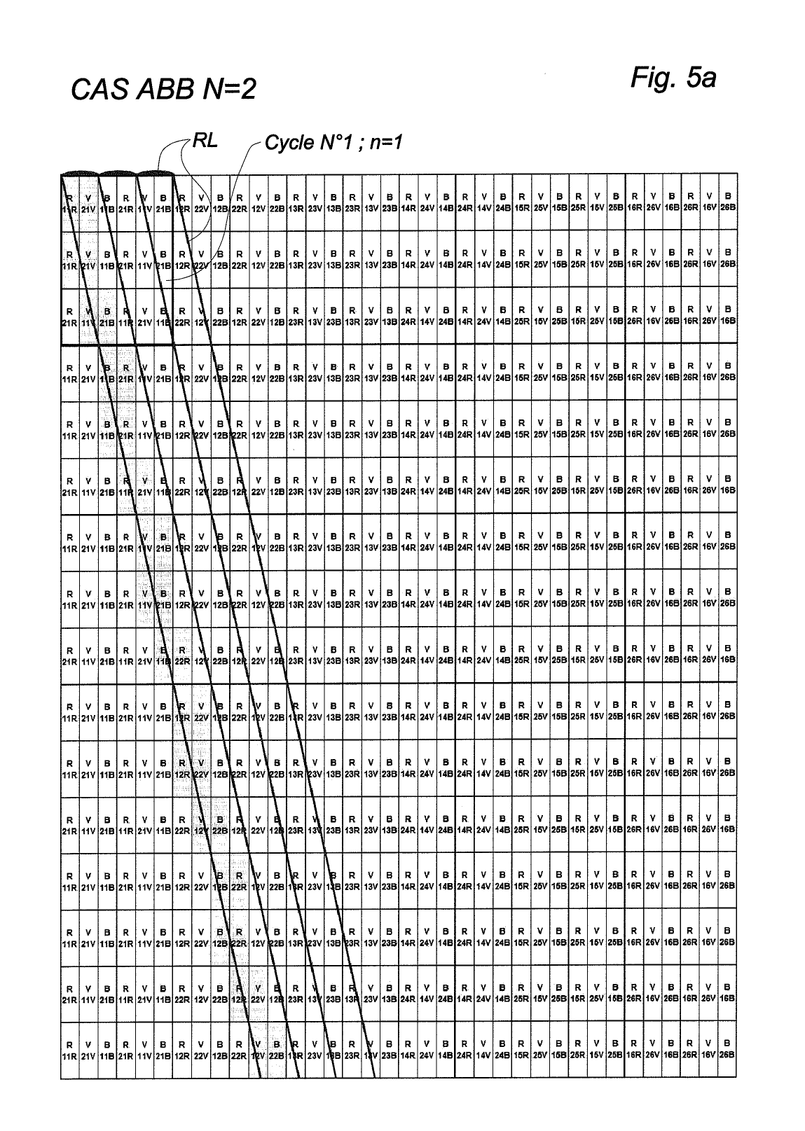

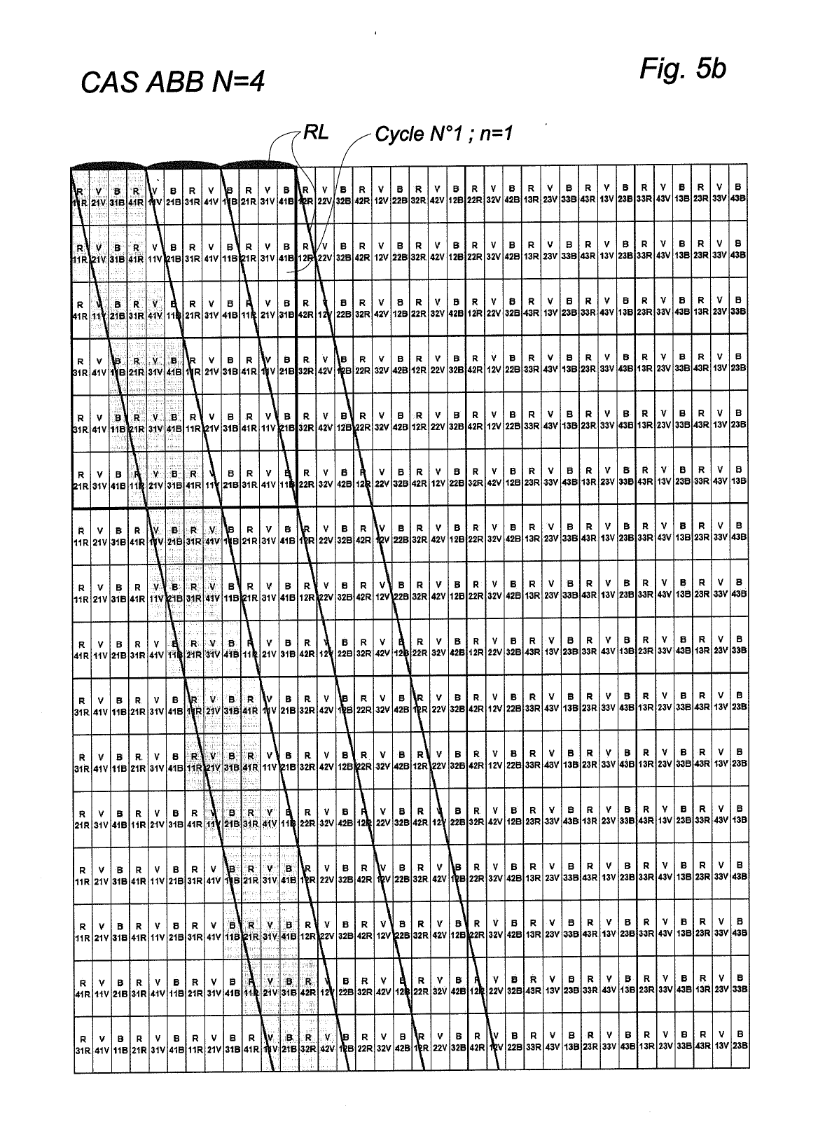

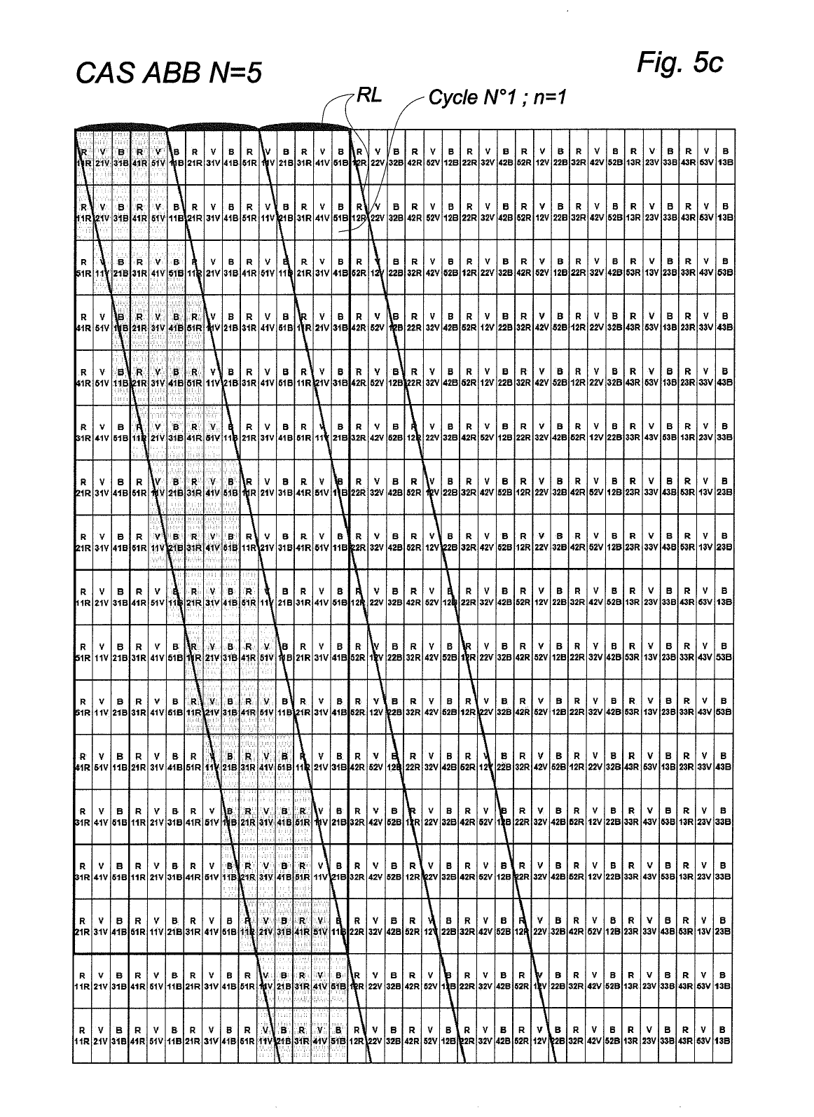

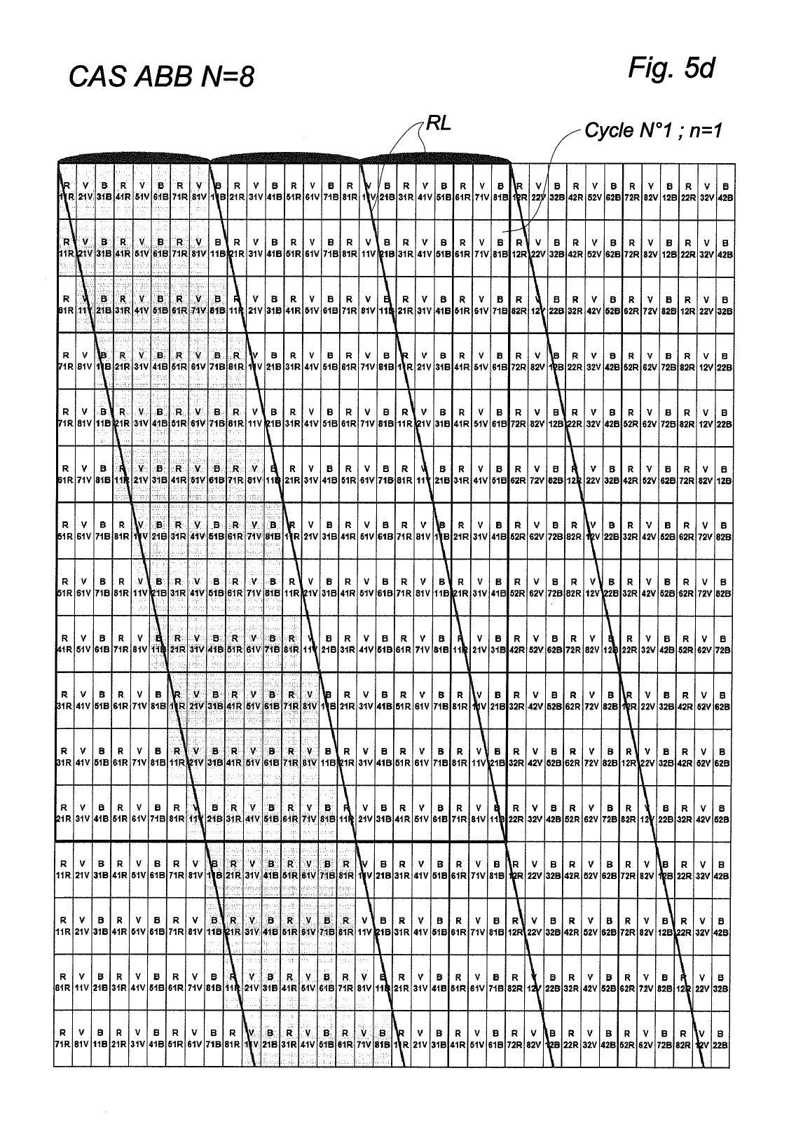

FIG. 5a (N=2) corresponds to applying the method A followed by two iterations of the method B (sequence ABB). A sequence ABB leads to alternating two identical rows and one row that is different from the other two. For N=2, the cycle extends over three rows with the first two rows beginning with the sub-pixel 11R, the next with the sub-pixel 21R, the next two rows that initiate the following cycle beginning with 11R. The following cycle (cycle No. 2) begins on the fourth row that begins with the sub-pixel 11R.

In FIG. 5b (N=4), the cycle extends over six rows with two successive sequences ABB. It begins with two identical rows beginning with the sub-pixel 11R (method A), the third row is offset by one pitch (method B) and begins with the sub-pixel 41R, the fourth row is likewise offset by one pitch (iteration B) and begins with the sub-pixel 31R. The fifth row is identical with the fourth and the sixth row is offset by one pitch (method B) and begins with the sub-pixel 21R. The iteration of B is then applied leading to the seventh row which begins with the sub-pixel R1. The cycle which extends over six rows of the screen, is thus terminated and the following cycle (cycle No. 2) begins on the seventh row which begins with the sub-pixel 11R.

In FIG. 5c (N=5), a cycle extends over fifteen rows, given that the reappearance of a row beginning with 11R (ninth row) is followed by an application of the method B which leads to a tenth row beginning with the sub-pixel 51R, whereas the cycle is initiated by two identical rows beginning with 11R.

In FIG. 5d (N=8), the cycle extends over twelve rows, with four successive sequences ABB.

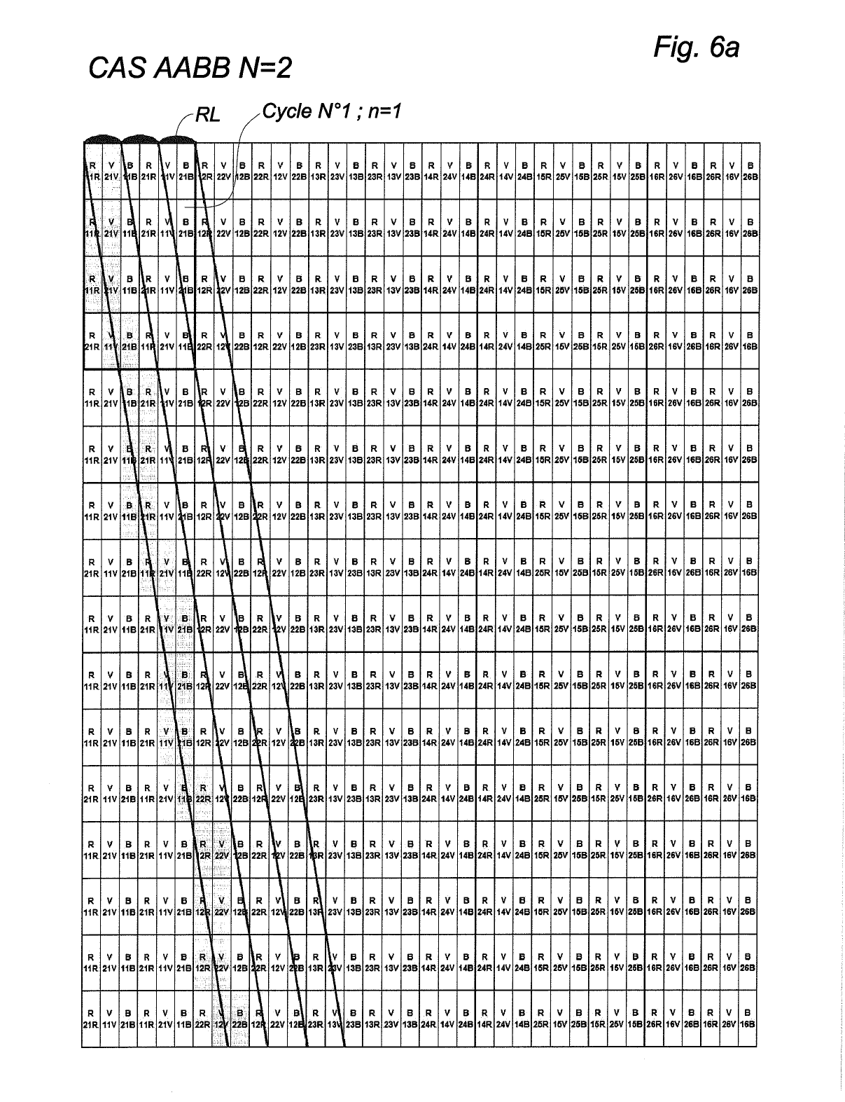

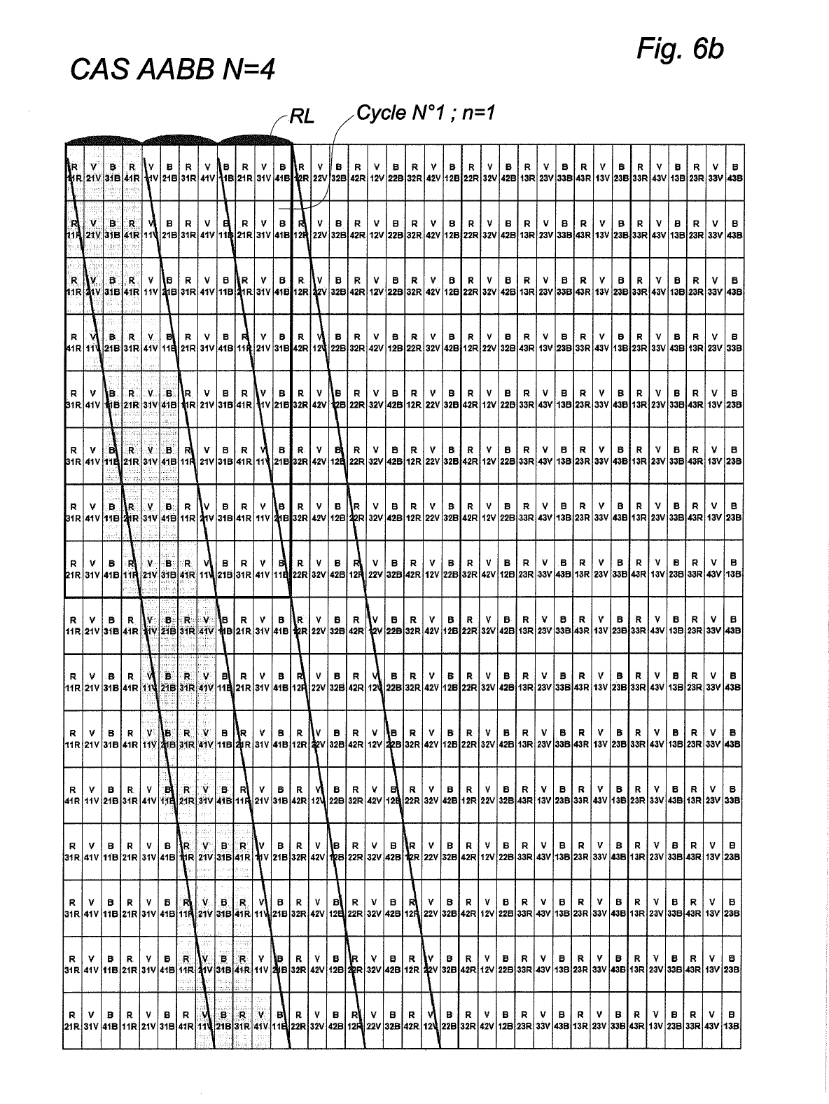

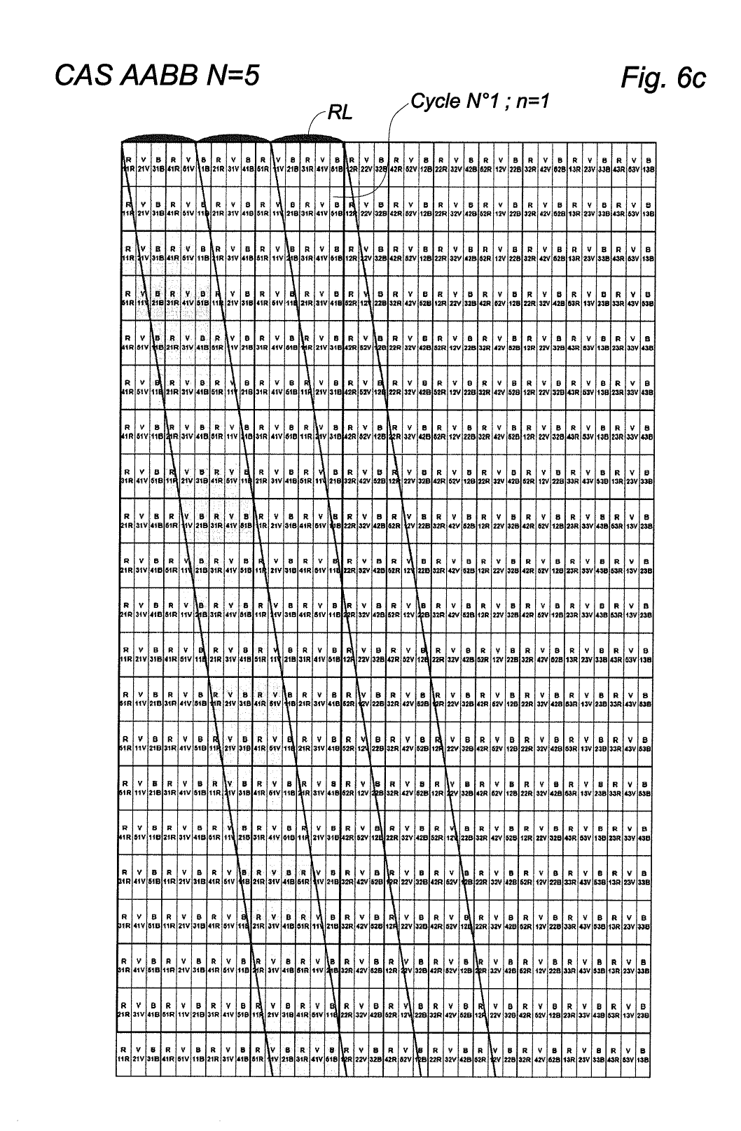

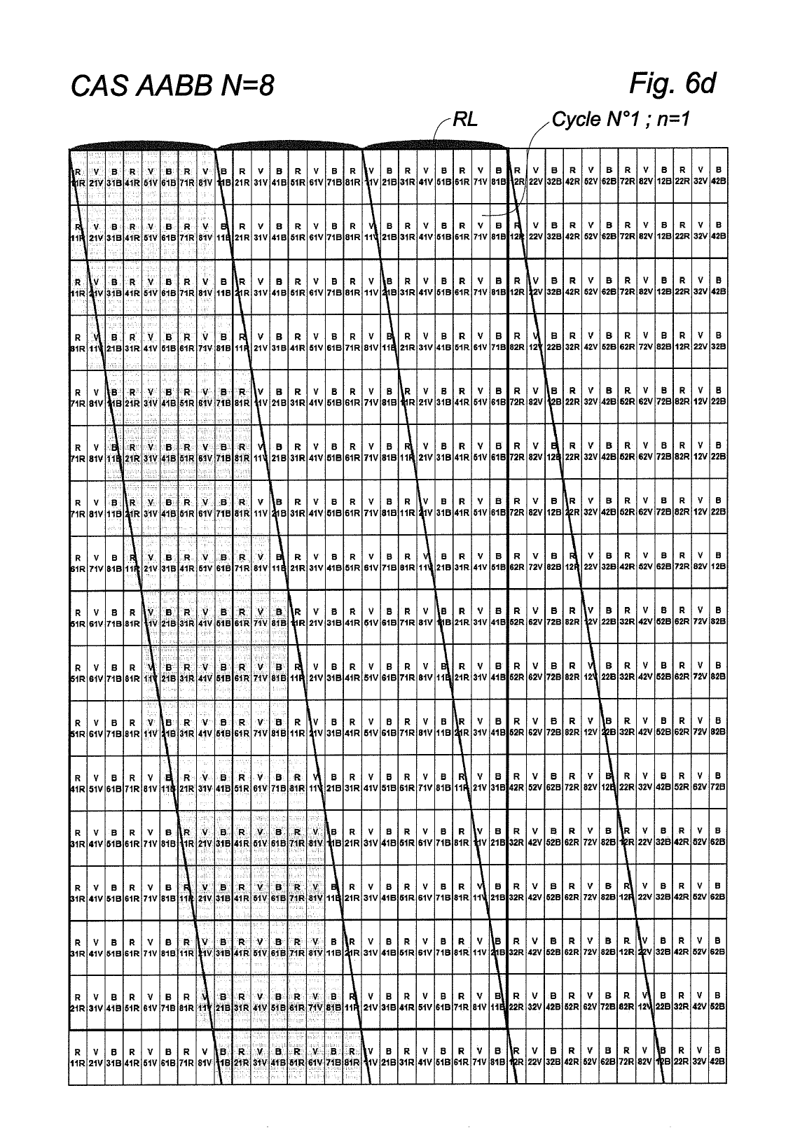

FIG. 6a (N=2) implements an alternation comprising an alternating double iteration of the two methods (sequence AABB). A cycle extends over 2N=4 rows, i.e. three rows that begin with the sub-pixel 11R (double iteration of the method AA) and a row that begins with the sub-pixel 21R (method B), followed by an iteration of the method B which returns to a row beginning by 11R, which row is the first row of the following cycle.

In FIG. 6b (N=4), the same sequence leads to a cycle that extends over 2N=8 rows, the first three rows of cycle No. 1 beginning with the sub-pixel 11R as in the preceding case, the fourth row beginning with the sub-pixel 41R (method B), the fifth row with the sub-pixel 31R (reiterating B), the sixth and seventh rows likewise beginning with the sub-pixel 31R (double iteration of A), and the next two rows beginning respectively with 21R for the eighth row (iteration of B) and 11R for the ninth row (second iteration of B), thereby initiating the following cycle from the ninth row.

In FIG. 6c (N=5), the cycle extends over 4N=20 rows.

In FIG. 6d (N=8), the cycle extends over 2N=16 rows.

The method of the invention is particularly suitable when the number of viewpoints is not greater than eight. The values corresponding to these numbers are N=2, 4, 5, 7, 8. It is nevertheless possible to envisage using more than eight viewpoints (N=10, 11, 13, 14, 16, etc. . . . ) in certain applications.

For each of the viewpoints, the method described leads to columns of sub-pixels that are slightly ragged, but regular. These sub-pixels seen by the first lens of the array RL (or the first slot of the parallax array) are shown in gray.

The presence of two successive rows that are identical as implied by applying the method A serves to improve the separating power, with this being softened and unified by the one sub-pixel offset provided by applying the method B.

The mode AB is particularly suitable for screens in which the sub-pixels are very close together, as in high quality telephone screens.

For liquid crystal display (LCD) screens of size lying in the range 10 inches to 65 inches (1 inch=2.54 centimeters (cm)), the sequence ABB gives results that are particularly good because the spaces between sub-pixels on those screens are quite large.

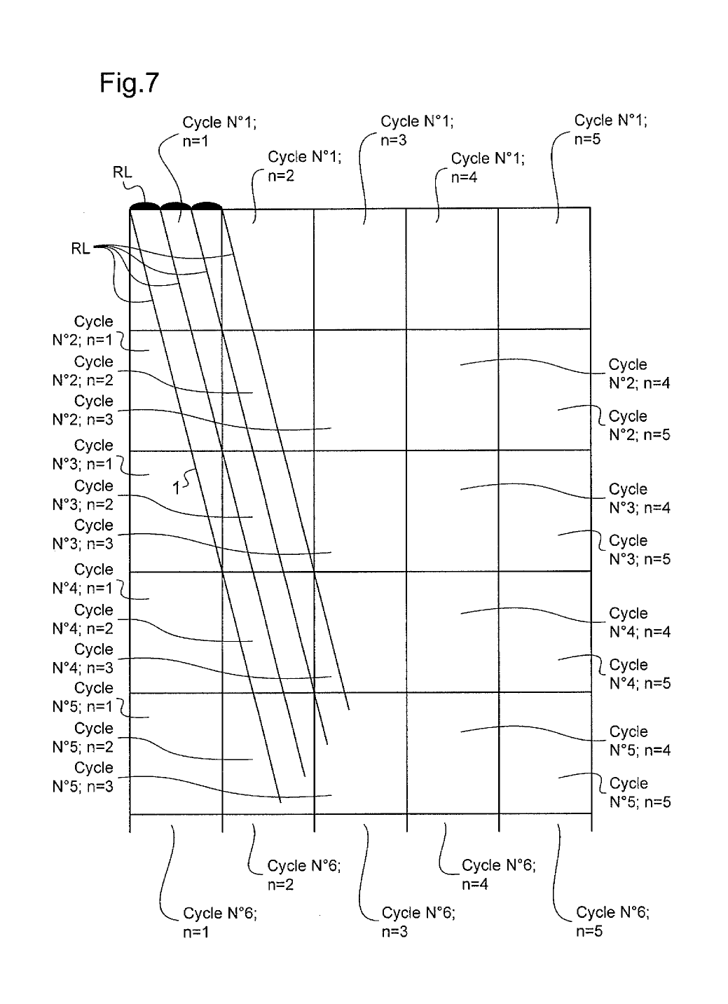

In all cases corresponding to the present invention, it is possible to use as the optical component a lens array or a parallax barrier that is inclined in the mean direction of the ragged columns of sub-pixels. This mean direction is particularly easy to define. Between the top and the bottom of a box corresponding to one cycle, the inclination always produces a lateral offset equal to one-third of the width of the base. The inclination of the array thus corresponds to the diagonal of a quadrilateral superposed vertically on three successive cycles, as shown in FIG. 7 which represents the display of cycles and the orientation of the lens array or of the parallax barrier. The orientation of the array is parallel to a line 1 which is the diagonal of the quadrilateral superposed on cycles Nos. 1, 2, and 3 for n=1.

It is also possible to use an optical component having a ragged axis corresponding to the selected sequence and to keep a display covering the sub-pixels displayed using one method or the other.

In order to facilitate the description, the examples all begin with the method A being applied to the first row. Since the principle of the invention relies on at least one alternation between the methods A and B during an elementary sequence, it will be understood that it is entirely possible to apply the method B to the first row. For example ABB becomes BBA or BAB, which comes to the same thing since the method iterates BBA, which gives rise to BBABBABBA or BABBABB . . . , which leads to an offset of one or two rows depending on how the iteration of the sequence ABB is implemented cyclically.

1. A method of displaying an autostereoscopic image having N viewpoints, on at least a portion of a screen having display pixels arranged in rows and columns, each display pixel comprising first, second, and third sub-pixels in alignment on a common row, each sub-pixel having a different color (R, V, B), the display rows of the screen presenting the same arrangement of sub-pixels, in which method N is greater than 1 and is not equal to a multiple of 3, the three sub-pixels of each display pixel displaying three sub-pixels of corresponding color component of pixels of the autostereoscopic image coming from at least two pixels of the same rank of at least two different viewpoints, wherein for at least one group of three successive screen rows comprising first, second, and third rows, the second row is identical to the first row, and for the third row, the spatial distribution of the three sub-pixels of the autostereoscopic image is offset relative to the second row by a pitch corresponding to one sub-pixel, the offsetting being in an elementary sequence AB, where A designates the fact that a row is identical to the preceding row, and B designates applying to a row of the image, relative to the preceding row, said offset of the sub-pixels of the autostereoscopic image through a pitch corresponding to one sub-pixel.

2. A method according to claim 1, wherein the display sequence comprises at least one elementary sequence AB and is repeated in a display cycle having a group of rows of the screen.

3. A method according to claim 2, wherein the display sequence is AB and in that a display cycle has 2N rows of the screen.

4. A method according to claim 2, wherein the display sequence is AAB and in that the display cycle has 3N rows of the screen.

5. A method according to claim 2, wherein the display sequence is ABB.

6. A method according to claim 5, wherein that N=2 or N=4 and in that the display sequence extends over six rows of the screen.

7. A method according to claim 5, wherein N=5 and in that the display cycle extends over fifteen rows of the screen.

8. A method according to claim 5, wherein N=8 and in that the display cycle extends over twelve rows of the screen.

9. A method according to claim 2, wherein the display sequence is AABB.

10. A method according to claim 9, wherein N is an even number and in that the cycle extends over 2N rows.

11. A method according to claim 10, wherein N=2, 4, or 8.

12. A method according to claim 9, wherein N=5 and in that the cycle extends over twenty rows.
